(19) United States
(12) Patent Application Publication
(10) Pub. No.: US 2014/0347373 A1
(43) Pub. Date: Nov. 27, 2014

(54) METHOD OF GENERATING TERRAIN MODEL AND DEVICE USING THE SAME

(71) Applicant: Electronics and Telecommunications Research Institute, Daejeon (KR)

(72) Inventors: Seung Hyup SHIN, Daejeon (KR); Il Kwon JEONG, Daejeon (KR)

(73) Assignee: Electronics and Telecommunications Research Institute, Daejeon (KR)

(21) Appl. No.: 14/052,007

(22) Filed: Oct. 11, 2013

(30) Foreign Application Priority Data
May 27, 2013 (KR) 10-2013-0059493

(51) Int. Cl. G06T 1/20

(52) U.S. Cl. CPC G06T 1/20
USPC 345/505

(57) ABSTRACT

There are provided a method of generating a terrain model and a device using the same. The method of generating a terrain model includes dividing a primitive terrain model into a plurality of partial terrain sections based on a predetermined criterion, assigning the plurality of partial terrain sections to a multiprocessor, and generating a final terrain model by performing a terrain transformation simulation of the plurality of partial terrain sections through parallel processing based on the multiprocessor. Therefore, it is possible to rapidly generate a realistic terrain model.

### CLAIM FOR PRIORITY

This application claims priority to Korean Patent Application No. 10-2013-0059493 filed on May 27, 2013 in the Korean Intellectual Property Office (KIPO), the entire contents of which are hereby incorporated by reference.

### BACKGROUND

1. Technical Field

Example embodiments of the present invention relate to terrain model generating technology, and more specifically, to a method of generating a terrain model for rapidly generating a realistic terrain and a device using the same.

2. Related Art

In digital content related fields, demands for special effect simulation methods for generating realistic images are increasing. In addition, demands for quality improvement of a background terrain model used as a foundation of the special effect simulation methods are also increasing. In particular, in examples of “2012” dealing with a large-scale natural disaster and “Avatar” having issues with high-quality virtual terrain scenes, the terrain model is not a simple background accessory but is regarded as a main factor influencing reality of films.

In order to realistically represent such a large-scale terrain model, terrain formation processes spanning several decades to several millions of years need to be reflected, and in general, skilled operators generate the terrain model by combining and modeling a plurality of reference scenes.

A real terrain is formed by a variety of factors, for example, upheaval and depression due to earthquakes or volcanic activity, soil erosion due to water, wind, and glaciation, and weathering of rocks due to biological or thermo-chemical factors. In order to generate a high-quality terrain model in which such various factors are reflected, a considerable amount of time and effort is necessary.

### SUMMARY

Accordingly, example embodiments of the present invention are provided to substantially obviate one or more problems due to limitations and disadvantages of the related art.

Example embodiments of the present invention provide a method of generating a terrain model for rapidly generating a realistic terrain through parallel simulation based on a multiprocessor.

Example embodiments of the present invention also provide a device for generating a terrain model for rapidly generating a realistic terrain through parallel simulation based on a multiprocessor.

In some example embodiments, a method of generating a terrain model includes dividing a primitive terrain model into a plurality of partial terrain sections based on a predetermined criterion, assigning the plurality of partial terrain sections to a multiprocessor, and generating a final terrain model by performing a terrain transformation simulation of the plurality of partial terrain sections through parallel processing based on the multiprocessor.

In the dividing of the plurality of partial terrain sections, the primitive terrain model may be divided such that the plurality of partial terrain sections overlap by a predetermined area.

In the generating of the final terrain model, the multiprocessors may share a terrain transformation simulation result of an overlapping area among the plurality of partial terrain sections.

In the dividing of the plurality of partial terrain sections, the primitive terrain model may be divided such that the plurality of partial terrain sections have the same size.

The generating of the final terrain model may include separating the partial terrain section into a high-resolution terrain texture and a low-resolution terrain texture through a multi-resolution analysis, obtaining an example terrain model having a greater similarity with the low-resolution terrain texture of the partial terrain section than a preset criterion among example terrain models that are previously stored in a database, and generating the final terrain model by combining a high-resolution terrain texture of the obtained example terrain model and the low-resolution terrain texture of the partial terrain section.

In the obtaining of the example terrain model, the example terrain model may be obtained by comparing a terrain similarity in units of polygons.

The method of generating a terrain model may further include correcting the final terrain model based on a Poisson image editing method.

The multiprocessor may be a multi-graphic processor unit (GPU) supporting asynchronous copying.

In other example embodiments, a device for generating a terrain model includes a multiprocessor configured to divide a primitive terrain model into a plurality of partial terrain sections based on a predetermined criterion, assign the plurality of partial terrain sections to the multiprocessor, and generate a final terrain model by performing a terrain transformation simulation of the plurality of partial terrain sections through parallel processing based on the multiprocessor, and a database configured to store information to be processed by the multiprocessor and information processed by the multiprocessor.

When the primitive terrain model is divided into the plurality of partial terrain sections, the multiprocessor may divide the primitive terrain model such that the plurality of partial terrain sections overlap by a predetermined area.

When the final terrain model is generated, the multiprocessors may share a terrain transformation simulation result of an overlapping area among the plurality of partial terrain sections.

When the primitive terrain model is divided into the plurality of partial terrain sections, the multiprocessor may divide the primitive terrain model such that the plurality of partial terrain sections have the same size.

When the final terrain model is generated, the multiprocessor may separate the partial terrain section into a high-resolution terrain texture and a low-resolution terrain texture through a multi-resolution analysis, obtain an example terrain model having a greater similarity with the low-resolution terrain texture of the partial terrain section than a preset criterion among example terrain models that are previously stored in the database, and generate the final terrain model by combining a high-resolution terrain texture of the obtained example terrain model and the low-resolution terrain texture of the partial terrain section.

When the example terrain model is obtained, the multiprocessor may obtain the example terrain model by comparing a terrain similarity in units of polygons.

The multiprocessor may correct the final terrain model based on a Poisson image editing method.

The multiprocessor may be a multi-GPU supporting asynchronous copying.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method of generating a terrain model according to an embodiment of the invention.

FIG. 2 is a block diagram illustrating a primitive terrain model divided into a plurality of partial terrain sections.

FIG. 3 is a block diagram illustrating the primitive terrain model assigned to a multiprocessor.

FIG. 4 is a conceptual diagram illustrating a process of a terrain erosion simulation.

FIG. 5 is a flowchart illustrating operations of generating a final terrain model in the method of generating a terrain model according to the embodiment of the invention.

FIG. 6 is a conceptual diagram illustrating processes of generating the final terrain model.

FIG. 7 is a block diagram illustrating a device for generating a terrain model according to another embodiment of the invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings. In order to facilitate overall understanding of the invention, like reference numerals in the drawings denote like elements, and thus the description thereof will not be repeated.

In general, terrain generation methods are classified as, for example, a brush-based terrain generation method, a noise-based terrain generation method, and a simulation-based terrain generation method. Terrain generation proceeds with a trial-and-error method in which such terrain generation methods are performed until a desired terrain is obtained.

The brush-based terrain generation method has an advantage in that an operator can directly control a shape of a terrain. However, when a large-scale terrain is generated, an amount of work exponentially increases in the brush-based terrain generation method, a significant amount of time is thereby consumed to generate a terrain, and it is difficult to represent a realistic terrain shape.

The noise-based terrain generation method is a method in which details are usually added to a wide area using a noise function and which can represent a fractal property of the terrain by merging noises of a multi-signal bandwidth. However, since an entire target area is affected by parameter manipulation of the noise function, it is difficult to locally manipulate the area, and a considerable amount of time and effort is necessary until a desired result is obtained.

The simulation-based terrain generation method models an erosion process in a variety of shapes. In general, in order to calculate soil deformation due to water movement, a space in which a terrain is defined is divided into grid shapes, and water movement and soil movement are calculated at each grid point. In this case, in order to secure reality and stability of the simulation, the erosion process is divided into fine time steps and is repeatedly performed. Therefore, there is a problem in that such a process consumes a great amount of time.

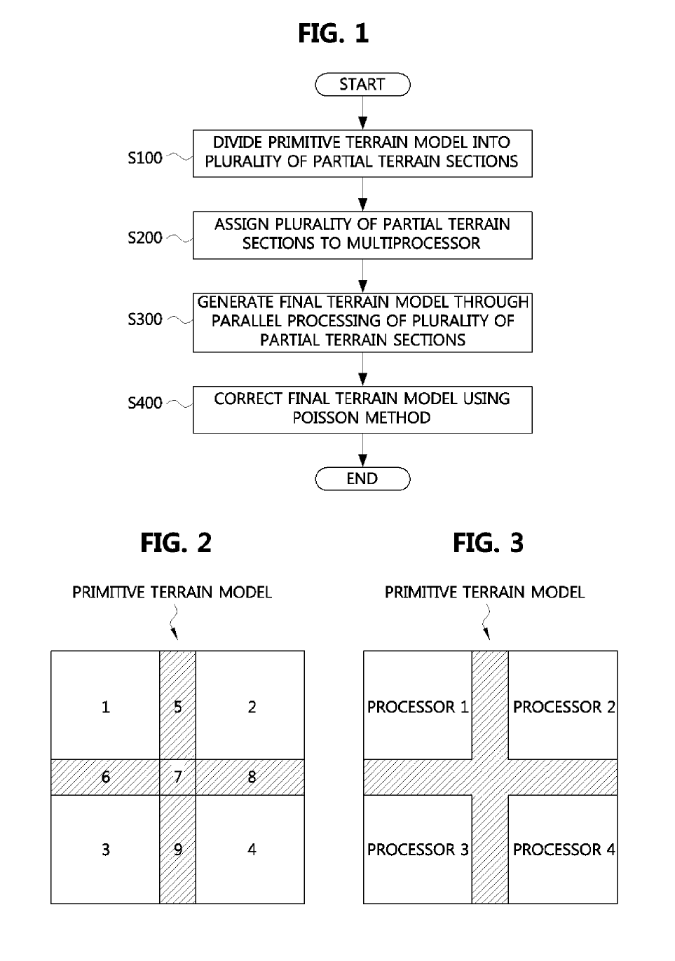

FIG. 1 is a flowchart illustrating a method of generating a terrain model according to an embodiment of the invention.

As illustrated in FIG. 1, the method of generating a terrain model includes an operation of dividing a primitive terrain model into a plurality of partial terrain sections based on a predetermined criterion (S100), an operation of assigning the plurality of partial terrain sections to a multiprocessor (S200), and an operation of generating a final terrain model by performing a terrain transformation simulation of the plurality of partial terrain sections through parallel processing based on the multiprocessor (S300).

In addition, the method of generating a terrain model may further include correcting the final terrain model based on a Poisson image editing method (S400).

Here, the multiprocessor may include a plurality of GPUs, and the GPUs may support asynchronous copying. The plurality of GPUs may include GPUs having the same performance (that is, the same clock frequency), or may include GPUs having different performance (that is, different clock frequencies).

Here, each operation in FIG. 1 may be performed in a device for generating a terrain model in FIG. 7. A detailed configuration and functions of the device for generating a terrain model will be described below.

In operation S100, the device for generating a terrain model may divide the primitive terrain model into the plurality of partial terrain sections based on the predetermined criterion. In this case, the device for generating a terrain model may divide the primitive terrain model such that the plurality of partial terrain sections overlap by a predetermined area. Moreover, the device for generating a terrain model may divide the primitive terrain model such that the plurality of partial terrain sections have the same size. Further, the device for generating a terrain model may divide the primitive terrain model such that the number of partial terrain sections is the same as the number of processors included in the multiprocessor.

FIG. 2 is a block diagram illustrating the primitive terrain model divided into the plurality of partial terrain sections.

As illustrated in FIG. 2, when the multiprocessor includes four processors (processors 1 to 4), the device for generating a terrain mode may divide the primitive terrain model into four partial terrain sections. In this case, when a size of the primitive terrain model is 800×800 (pixels), the device for generating a terrain model may generate four partial terrain sections having the same size of 500×500 (pixels).

Meanwhile, the device for generating a terrain model may set a size of an overlapping area (that is, a shared area) between adjacent partial terrain sections to less than ¼ of a side of the primitive terrain model. That is, when a size of the side of the primitive terrain model is 800 pixels, the device for generating a terrain model may set the size of the overlapping area between adjacent partial terrain sections to less than 200 pixels.

Based on these conditions, the device for generating a terrain model may generate a partial terrain section 1 including signs 1, 5, 6, and 7, a partial terrain section 2 including signs 2, 5, 7, and 8, a partial terrain section 3 including signs 3, 6, 7, and 9, and a partial terrain section 4 including signs 4, 7, 8, and 9.

Here, the partial terrain sections 1 to 4 have the same size. The partial terrain section 1 shares signs 5 and 7 with the partial terrain section 2, shares signs 6 and 7 with the partial terrain section 3, and shares sign 7 with the partial terrain section 4. The partial terrain section 2 shares signs 5 and 7 with the partial terrain section 1, shares sign 7 with the partial terrain section 3, and shares signs 7 and 8 with the partial terrain section 4.

The partial terrain section 3 shares signs 6 and 7 with the partial terrain section 1, shares sign 7 with the partial terrain section 2, and shares signs 7 and 9 with the partial terrain section 4. The partial terrain section 4 shares sign 7 with the partial terrain section 1, shares signs 7 and 8 with the partial terrain section 2, and shares signs 7 and 9 with the partial terrain section 3.

Meanwhile, when the multiprocessor includes GPUs having different performance, the device for generating a terrain model may generate partial terrain sections having different sizes based on performance of the GPU. That is, the device for generating a terrain model may generate a partial terrain section having a relatively large size for a GPU having relatively high performance and generate a partial terrain section having a relatively small size for a GPU having relatively low performance.

With reference to FIG. 1 again, in operation S200, the device for generating a terrain model may assign the plurality of partial terrain sections to the multiprocessor. When the same number of the plurality of partial terrain sections as the number of processor are generated, the device for generating a terrain model may assign each partial terrain section to a corresponding processor.

FIG. 3 is a block diagram illustrating the primitive terrain model assigned to the multiprocessor.

As illustrated in FIG. 3, the device for generating a terrain model may assign each of the partial terrain sections to the corresponding processor. Here, since the primitive terrain model in FIG. 3 is the same as the primitive terrain model in FIG. 2, the device for generating a terrain model may assign a partial terrain section 1 (that is, signs 1, 5, 6, and 7) to a processor 1, a partial terrain section 2 (that is, signs 2, 5, 7, and 8) to a processor 2, a partial terrain section 3 (that is, signs 3, 6, 7, and 9) to a processor 3, and a partial terrain section 4 (that is, signs 4, 7, 8, and 9) to a processor 4. Meanwhile, a shaded section in FIG. 3 indicates a shared area between the processors.

With reference to FIG. 1 again, in operation S300, the device for generating a terrain model may generate a final terrain model by performing the terrain transformation simulation of the plurality of partial terrain sections through parallel processing based on the multiprocessor.

The terrain transformation simulation method uses a terrain model (for example, digital elevation map (DEM) data based on actual measured values, data generated by procedural methods, and data generated by sketch-based methods) made by a variety of methods as an input. This terrain model is stored as a form of a height map.

Here, the height map refers to a data structure in which a height in a vertical direction is set at each point of 2D regular grids. Since a large-scale terrain model has a great height change in a vertical direction, it is possible to effectively represent a large-scale terrain using the height map.

Factors of terrain changes are diverse and are classified as, for example, upheaval, depression, erosion, and weathering. The factors of such terrain changes may be independently modeled and may be sequentially applied within one time step of a terrain simulation. The terrain simulation proceeds with a method in which a process of calculating a result changed after a short time elapses based on information at a current time is repeated. In this case, a used time difference refers to the time step of the terrain simulation.

Terrain Erosion Simulation

Water erodes soil, the eroded soil moves and is deposited in a place in which a flow velocity is slow. The simulation in which such terrain erosion is reflected may be performed by a known Musgrave method.

First, information on each grid point (x, y) of the height map is defined with respect to a time t as follows.
height of terrain: hₜ(x, y)
water amount: wₜ(x, y)
rain amount: rₜ(x, y)
amount of soil included in water: sₜ(x, y)
movement velocity of water: vₜ(x, y)
maximum amount of soil that can be eroded by moving water: cₛ

In this case, the terrain erosion simulation proceeds by repeating the following processes.

(1) An increase in a water amount at each grid point due to rain may be calculated using the following Formula 1.

w^{v}ₜₐ=w^{v}ₜ+r(x,y) Formula 1

In Formula 1, w^{v}ₜₐ represents an intermediate variable for calculating a final simulation value. That is, w^{v}ₜₐ represents a temporarily used value in a process of calculating w^{v}_{{t+1}} from w^{v}ₜ.

(2) Water movement due to a height difference between each grid point (u) and a surrounding grid point (v) may be calculated using the following Formula 2.

[symbol]

deltaw=min(w^{v}ₜₐ,(w^{v}ₜₐ+h^{v}ₜ)−(w^{u}ₜ+h^{u}ₜ))

w^{v}ₜ₊₁=w^{v}ₜₐ− [symbol] deltaw Formula 2

(3) Soil erosion due to water may be calculated using the following Formula 3.

s^{v}ₐ=(1−K_{d})s^{v}ₜ Formula 3

In Formula 3, K_{d} is a deposition constant and determines how much soil dissolved in water is deposited per unit time.

(4) Soil deposition included in water may be calculated using the following Formula 4.

h^{v}ₜ₊₁=h^{v}ₜ+K_{d}(s^{v}ₜ−cₛ)

s^{v}ₜ₊₁=s^{v}ₐ+cₛ Formula 4

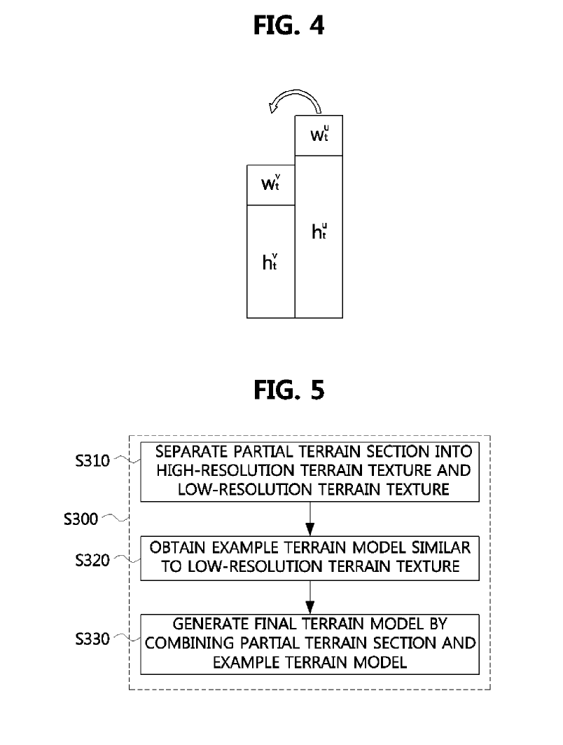

FIG. 4 is a conceptual diagram illustrating a process of the terrain erosion simulation.

As illustrated in FIG. 4, h^{u}ₜ indicates a height at a grid point u at a time t, h^{v}ₜ indicates a height at a grid point v at a time t, w^{u}ₜ indicates an incremented amount of water at a grid point u at a time t, and w^{v}ₜ indicates an incremented amount of water at a grid point v at a time t. That is, due to a height difference between a grid point v and a grid point u, soil positioned at the grid point u moves to the grid point v.

Terrain Weathering Simulation

Rocks repeatedly expand and contract due to a temperature difference between day and night, and cracks accordingly occur inside of the rocks. After a considerable amount of time elapses, the rocks in which cracks have occurred break down and evenly move to nearby low positions. This is a phenomenon in which height information of the grid point is gradually flattened and may be modeled using the following Formula 5.

h^{v}_{{t+1}}= [symbol] alpha*h^{v}ₜ+(1− [symbol] alpha)* [symbol] sum_{{for each neighbor u}}h^{u}_{{t+1}} Formula 5

Here, t indicates a time, h^{v} indicates a height at a grid point v, h^{u} indicates a height at a grid point u, and [symbol] alpha indicates a coefficient for adjusting a flattening rate.

In this way, the device for generating a terrain model may perform the terrain transformation simulation based on the known Musgrave method and generate the final terrain model. That is, with reference to FIGS. 2 and 3 again, the processor 1 may perform the terrain transformation simulation of the partial terrain section 1 (that is, signs 1, 5, 6, and 7) based on the Musgrave method, and the processor 2 may perform the terrain transformation simulation of the partial terrain section 2 (that is, signs 2, 5, 7, and 8) based on the Musgrave method.

The processor 3 may perform the terrain transformation simulation of the partial terrain section 3 (that is, signs 3, 6, 7, and 9) based on the Musgrave method, and the processor 4 may perform the terrain transformation simulation of the partial terrain section 4 (that is, signs 4, 7, 8, and 9) based on the Musgrave method.

After these processes are preformed, the processors may exchange data (for example, a terrain height (hₜ), a water amount (wₜ), a rain amount (rₜ), an amount of soil mixed in water (sₜ), and a water velocity (vₜ)) on the overlapping area.

For example, the processor 1 may provide data on an area indicated by signs 5 and 7 to the processor 2, provide data on an area indicated by signs 6 and 7 to the processor 3, and provide data on an area indicated by sign 7 to the processor 4. The processor 2 may provide data on an area indicated by signs 5 and 7 to the processor 1, provide data on an area indicated by sign 7 to the processor 3, and provide data on an area indicated by signs 7 and 8 to the processor 4.

The processor 3 may provide data on an area indicated by signs 6 and 7 to the processor 1, provide data on an area indicated by sign 7 to the processor 2, and provide data on an area indicated by signs 7 and 9 to the processor 4. The processor 4 may provide data on an area indicated by sign 7 to the processor 1, provide data on an area indicated by signs 7 and 8 to the processor 2, and provide data on an area indicated by signs 7 and 9 to the processor 3.

Here, when data in a memory of one processor moves to a memory of an adjacent processor, the data in the memory of one processor moves to a main memory first, and then moves to the memory of the adjacent processor. That is, data in a memory of the processor 1 moves to a main memory, and then moves to a memory of the processor 2, the processor 3 or the processor 4.

After the processors exchange data on the overlapping area, the processors may perform the terrain transformation simulation again based on the exchanged data. In this case, the terrain transformation simulation may be performed based on the known Musgrave method.

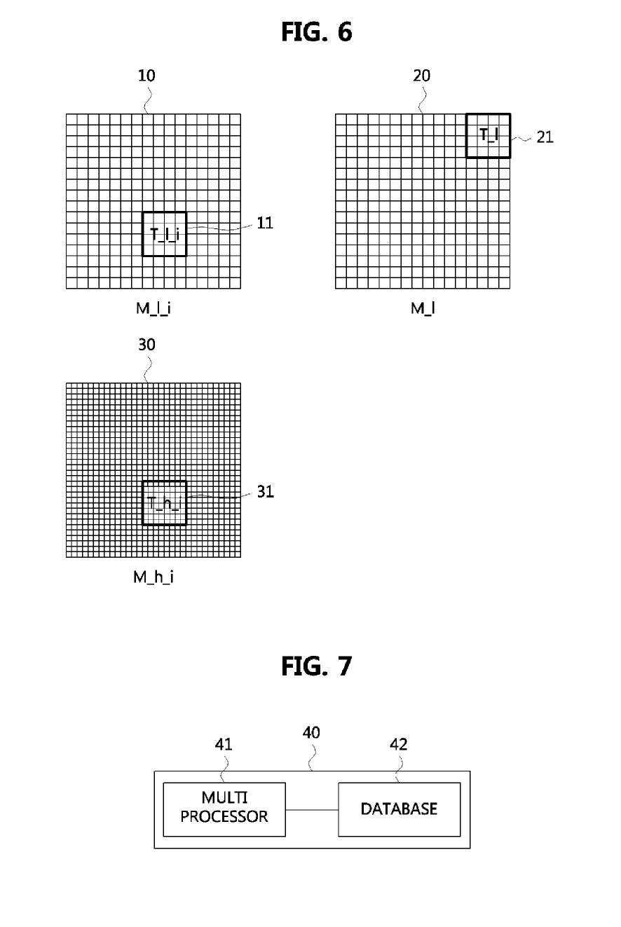

Meanwhile, in operation S300, the device for generating a terrain model may generate the final terrain model through an example-based simulation method. A detailed description thereof will be provided below with reference to FIGS. 5 and 6.

FIG. 5 is a flowchart illustrating operations of generating the final terrain model in the method of generating a terrain model according to the embodiment of the invention.

As illustrated in FIG. 5, an operation of generating the final terrain model (S300) may include an operation of separating the partial terrain section into a high-resolution terrain texture and a low-resolution terrain texture through a multi-resolution analysis (S310), an operation of obtaining an example terrain model having a greater similarity with the low-resolution terrain texture of the partial terrain section than a preset criterion among example terrain models that are previously stored in a database (S320), and an operation of generating the final terrain model by combining a high-resolution terrain texture of the obtained example terrain model and the low-resolution terrain texture of the partial terrain section (S330).

In operation S310, the device for generating a terrain model may separate the partial terrain section into the high-resolution terrain texture and the low-resolution terrain texture through the multi-resolution analysis. Moreover, the device for generating a terrain model may directly separate the primitive terrain model into a high-resolution terrain texture and a low-resolution terrain texture rather than the partial terrain section. Here, the multi-resolution analysis method is known technology in which given data is considered as several combined frequencies and is analyzed or a part thereof is edited.

In operation S320, the device for generating a terrain model may obtain the example terrain model having a greater similarity with the low-resolution terrain texture of the partial terrain section than the preset criterion among the example terrain models that are previously stored in the database. The example terrain model that is previously stored in the database refers to a high-quality terrain model that is previously generated through the terrain transformation simulation.

The device for generating a terrain model may separate the example terrain model into a high-resolution terrain texture and a low-resolution terrain texture through the multi-resolution analysis and compare the similarity between the low-resolution terrain texture of the partial terrain section (or the primitive terrain model) and the low-resolution terrain texture of the example terrain model. In this case, the device for generating a terrain model may compare the similarity between the low-resolution terrain texture of the partial terrain section (or the primitive terrain model) and the low-resolution terrain texture of the example terrain model in units of polygons.

When a terrain similarity between the low-resolution terrain texture of the partial terrain section (or the primitive terrain model) and the low-resolution terrain texture of the example terrain model is greater than the preset criterion (for example, a similarity of 80%), the device for generating a terrain model may obtain the example terrain model corresponding to the low-resolution terrain texture.

In operation S330, the device for generating a terrain model may generate the final terrain model by combining the high-resolution terrain texture of the obtained example terrain model and the low-resolution terrain texture of the partial terrain section (or the primitive terrain model). The device for generating a terrain model may obtain the high-resolution terrain texture of the example terrain model obtained in operation S320 and generate the final terrain model by combining the high-resolution terrain texture of the obtained example terrain model and the low-resolution terrain texture of the partial terrain section (or the primitive terrain model).

The device for generating a terrain model may generate one final terrain model by combining the plurality of partial terrain sections on which such processes have been performed.

FIG. 6 is a conceptual diagram illustrating processes of generating the final terrain model.

As illustrated in FIG. 6, M_l 20 indicates the low-resolution terrain texture of the partial terrain section (or the primitive terrain model), and T_{—}1 21 indicates a part included in M_l 20. M_l_i 10 indicates the low-resolution terrain texture of the example terrain model, and T_l_i 11 indicates a part included in M_l_i 10. M_h_i 30 indicates the high-resolution terrain texture of the example terrain model, and T_h_i 31 indicates a part included in M_h_i 30.

The device for generating a terrain model may obtain a part similar to T_l 21 in the low-resolution terrain texture M_l_i 10 of the example terrain model. When T_l_i 11 is determined as a part similar to T_l 21, the device for generating a terrain model may obtain T_h_i 31 corresponding to T_l_i 11 in the high-resolution terrain texture M_h_i 30 of the example terrain model. Then, the device for generating a terrain model may generate the final terrain model by overlapping T_h_i 31 and T_l 21.

With reference to FIG. 1 again, in operation S400, the device for generating a terrain model may correct the final terrain model based on a Poisson image editing method. That is, in the terrain transformation simulation method, the simulation of the primitive terrain model is performed by each part, and then results thereof are collected to generate the final terrain model. In this case, there may be a visible seam between adjacent parts and the device for generating a terrain model may correct the adjacent parts to be naturally connected using the Poisson image editing method. Here, the Poisson image editing method refers to known technology used in the field of image processing.

The methods of generating a terrain model according to the invention may be implemented as a program instruction type that can be performed through various computer units and may be recorded in a computer-readable medium. The computer-readable medium may include a program instruction, a data file, a data structure, or combinations thereof. The program instruction recorded in the computer-readable medium may be specially designed or configured for the invention or may be an available known instruction to those skilled in computer software.

Examples of the computer-readable medium include a specially designed hardware device for storing and performing the program instruction such as a ROM, a RAM, and a flash memory. Examples of the program instruction include a machine code created by a compiler and a high-level language code that can be executed by a computer using, for example, an interpreter. In order to perform operations of the invention, the above hardware device may be configured to be operated as at least one software module.

FIG. 7 is a block diagram illustrating a device for generating a terrain model according to another embodiment of the invention.

As illustrated in FIG. 7, a device for generating a terrain model 40 may include a multiprocessor 41 and a database 42. The multiprocessor 41 may divide a primitive terrain model into a plurality of partial terrain sections based on a predetermined criterion, assign the plurality of partial terrain sections to the multiprocessor 41, and generate a final terrain model by performing a terrain transformation simulation of the plurality of partial terrain sections through parallel processing based on the multiprocessor 41.

In addition, the multiprocessor 41 may correct the final terrain model based on the Poisson image editing method.

Here, the multiprocessor 41 may include a plurality of GPUs, and the GPUs may support asynchronous copying. The plurality of GPUs may include GPUs having the same performance (that is, the same clock frequency), or may include GPUs having different performance (that is, different clock frequencies).

When the primitive terrain model is divided into the plurality of partial terrain sections, the multiprocessor 41 may divide the primitive terrain model such that the plurality of partial terrain sections overlap by a predetermined area. Moreover, the multiprocessor 41 may divide the primitive terrain model such that the plurality of partial terrain sections have the same size. Further, the multiprocessor 41 may divide the primitive terrain model such that the number of partial terrain sections is the same as the number of processors included in the multiprocessor 41.

That is, as illustrated in FIG. 2, the multiprocessor 41 may divide the primitive terrain model into the plurality of partial terrain sections (that is, the partial terrain sections 1 to 4).

The multiprocessor 41 may assign the plurality of partial terrain sections to a corresponding processor. That is, as illustrated in FIG. 3, the multiprocessor 41 may assign the partial terrain section 1 (that is, signs 1, 5, 6, and 7) to the processor 1, assign the partial terrain section 2 (that is, signs 2, 5, 7, and 8) to the processor 2, assign the partial terrain section 3 (that is, signs 3, 6, 7, and 9) to the processor 3, and assign the partial terrain section 4 (that is, signs 4, 7, 8, and 9) to the processor 4.

The multiprocessor 41 may generate the final terrain model by performing the terrain transformation simulation of the plurality of partial terrain sections through parallel processing. The multiprocessor 41 may perform the terrain transformation simulation based on the known Musgrave method.

As illustrated in FIGS. 2 and 3, the multiprocessor 41 may perform the terrain transformation simulation of the partial terrain section 1 (that is, signs 1, 5, 6, and 7) through the processor 1, perform the terrain transformation simulation of the partial terrain section 2 (that is, signs 2, 5, 7, and 8) through the processor 2, perform the terrain transformation simulation of the partial terrain section 3 (that is, signs 3, 6, 7, and 9) through the processor 3, and perform the terrain transformation simulation of the partial terrain section 4 (that is, signs 4, 7, 8, and 9) through the processor 4.

After these processes are preformed, the processors may share data (for example, a terrain height (ht), a water amount (wt), a rain amount (rt), an amount of soil mixed in water (st), and a water velocity (vt)) on the overlapping area. For example, in FIGS. 2 and 3, the processors 1 and 2 may share data on an area indicated by sign 5, the processors 1 and 3 may share data on an area indicated by sign 6, the processors 2 and 4 may share data on an area indicated by sign 8, the processors 3 and 4 may share data on an area indicated by sign 9, and the processors 1 to 4 may share data on an area indicated by sign 7.

After the processors share the data on the overlapping area, the processors may perform the terrain transformation simulation again based on the shared data. In this case, the terrain transformation simulation may be performed based on the known Musgrave method.

Meanwhile, when the final terrain model is generated, the multiprocessor 41 may separate the partial terrain section into a high-resolution terrain texture and a low-resolution terrain texture through a multi-resolution analysis, obtain an example terrain model having a greater similarity with the low-resolution terrain texture of the partial terrain section than a preset criterion among example terrain models that are previously stored in a database, and generate a final terrain model by combining a high-resolution terrain texture of the obtained example terrain model and the low-resolution terrain texture of the partial terrain section.

The multiprocessor 41 may separate the partial terrain section into the high-resolution terrain texture and the low-resolution terrain texture through the multi-resolution analysis. Moreover, the multiprocessor 41 may directly separate the primitive terrain model into a high-resolution terrain texture and a low-resolution terrain texture rather than the partial terrain section. Here, the multi-resolution analysis method is known technology in which given data is considered as several combined frequencies and is analyzed or a part thereof is edited.

The multiprocessor 41 may obtain the example terrain model having a greater similarity with the low-resolution terrain texture of the partial terrain section than the preset criterion among the example terrain models that are previously stored in the database. The example terrain model that is previously stored in the database refers to a high-quality terrain model that is previously generated through the terrain transformation simulation.

The multiprocessor 41 may separate the example terrain model into a high-resolution terrain texture and a low-resolution terrain texture through the multi-resolution analysis and compare the similarity between the low-resolution terrain texture of the partial terrain section (or, the primitive terrain model) and the low-resolution terrain texture of the example terrain model. In this case, the multiprocessor 41 may compare the similarity between the low-resolution terrain texture of the partial terrain section (or, the primitive terrain model) and the low-resolution terrain texture of the example terrain model in units of polygons.

When a terrain similarity between the low-resolution terrain texture of the partial terrain section (or the primitive terrain model) and the low-resolution terrain texture of the example terrain model is greater than the preset criterion (for example, a similarity of 80%), the multiprocessor 41 may obtain the example terrain model corresponding to the low-resolution terrain texture.

The multiprocessor 41 may obtain the high-resolution terrain texture of the example terrain model, and generate the final terrain model by combining the high-resolution terrain texture of the obtained example terrain model and the low-resolution terrain texture of the partial terrain section (or primitive terrain model).

The multiprocessor 41 may generate one final terrain model by combining the plurality of partial terrain sections on which such processes have been performed.

The multiprocessor 41 may correct the final terrain model based on the Poisson image editing method. That is, in the terrain transformation simulation method, the simulation of the primitive terrain model is performed by each part, and then results thereof are collected to generate the final terrain model. In this case, there may be a visible seam between adjacent parts and the multiprocessor 41 may correct the adjacent parts to be naturally connected using the Poisson image editing method. Here, the Poisson image editing method refers to known technology used in image processing fields.

The database 42 may store information to be processed by the multiprocessor 41 and information processed by the multiprocessor 41. For example, the database 42 may store, for example, the primitive terrain model, the partial terrain section, the example terrain model, the final terrain model, and the processor information.

According to the invention, it is possible to rapidly generate a realistic terrain by parallel simulation processing using the multiprocessor. Moreover, it is possible to more rapidly generate the realistic terrain with reference to pre-generated terrain models.

While the present invention has been described with reference to exemplary embodiments, it will be understood by those skilled in the art that various changes and modifications may be made without departing from the spirit and scope of the present invention as defined by the appended claims.

What is claimed is:

1. A method of generating a terrain model comprising:
dividing a primitive terrain model into a plurality of partial terrain sections based on a predetermined criterion;
assigning the plurality of partial terrain sections to a multiprocessor; and
generating a final terrain model by performing a terrain transformation simulation of the plurality of partial terrain sections through parallel processing based on the multiprocessor.

2. The method of claim 1, wherein, in the dividing of the plurality of partial terrain sections, the primitive terrain model is divided such that the plurality of partial terrain sections overlap by a predetermined area.

3. The method of claim 2, wherein, in the generating of the final terrain model, the multiprocessors share a terrain transformation simulation result of an overlapping area among the plurality of partial terrain sections.

4. The method of claim 1, wherein, in the dividing of the plurality of partial terrain sections, the primitive terrain model is divided such that the plurality of partial terrain sections have the same size.

5. The method of claim 1, wherein the generating of the final terrain model includes:
separating the partial terrain section into a high-resolution terrain texture and a low-resolution terrain texture through a multi-resolution analysis;
obtaining an example terrain model having a greater similarity with the low-resolution terrain texture of the partial terrain section than a preset criterion among example terrain models that are previously stored in a database; and
generating the final terrain model by combining a high-resolution terrain texture of the obtained example terrain model and the low-resolution terrain texture of the partial terrain section.

6. The method of claim 5, wherein, in the obtaining of the example terrain model, the example terrain model is obtained by comparing a terrain similarity in units of polygons.

7. The method of claim 1, further comprising correcting the final terrain model based on a Poisson image editing method.

8. The method of claim 1, wherein the multiprocessor is a multi-graphic processor unit (GPU) supporting asynchronous copying.

9. A device for generating a terrain model comprising:
a multiprocessor configured to divide a primitive terrain model into a plurality of partial terrain sections based on a predetermined criterion, assign the plurality of partial terrain sections to the multiprocessor, and generate a final terrain model by performing a terrain transformation simulation of the plurality of partial terrain sections through parallel processing based on the multiprocessor; and
a database configured to store information to be processed by the multiprocessor and information processed by the multiprocessor.

10. The device of claim 9, wherein, when the primitive terrain model is divided into the plurality of partial terrain sections, the multiprocessor divides the primitive terrain model such that the plurality of partial terrain sections overlap by a predetermined area.

11. The device of claim 10, wherein, when the final terrain model is generated, the multiprocessors share a terrain transformation simulation result of an overlapping area among the plurality of partial terrain sections.

12. The device of claim 9, wherein, when the primitive terrain model is divided into the plurality of partial terrain sections, the multiprocessor divides the primitive terrain model such that the plurality of partial terrain sections have the same size.

13. The device of claim 9, wherein, when the final terrain model is generated, the multiprocessor separates the partial terrain section into a high-resolution terrain texture and a low-resolution terrain texture through a multi-resolution analysis, obtains an example terrain model having a greater similarity with the low-resolution terrain texture of the partial terrain section than a preset criterion among example terrain models that are previously stored in the database, and generates the final terrain model by combining a high-resolution terrain texture of the obtained example terrain model and the low-resolution terrain texture of the partial terrain section.

14. The device of claim 13, wherein, when the example terrain model is obtained, the multiprocessor obtains the example terrain model by comparing a terrain similarity in units of polygons.

15. The device of claim 9, wherein the multiprocessor corrects the final terrain model based on a Poisson image editing method.

16. The device of claim 9, wherein the multiprocessor is a multi-graphic processor unit (GPU) supporting asynchronous copying.
